(19) United States
(12) Patent Application Publication
(10) Pub. No.: US 2012/0152934 A1
(43) Pub. Date: Jun. 21, 2012

(54) INDUCTION HEATING FUSER UNIT AND IMAGE FORMING APPARATUS INCLUDING THE SAME

(75) Inventor: Takashi KONDO, Yokohama (JP)

(73) Assignee: SAMSUNG ELECTRONICS CO., LTD., Suwon-si (KR)

(21) Appl. No.: 13/323,058

(22) Filed: Dec. 12, 2011

(30) Foreign Application Priority Data
Dec. 20, 2010 (JP) 2010-283651
May 25, 2011 (KR) 2011-0049800

(51) Int. Cl. H05B 6/10; H05B 6/06

(52) U.S. Cl. 219/635; 219/663

(57) ABSTRACT

An induction heating fuser unit including a series resonance circuit that includes an induction coil and condenser includes a phase comparing unit that compares a phase of a pulse for driving the series resonance circuit with a phase of a current flowing through the induction coil to obtain a phase difference; a resonant frequency following oscillation unit that changes an oscillation frequency such that a driving frequency of the series resonance circuit follows a resonant frequency of the series resonance circuit by using the phase difference obtained by the phase comparing unit; and a PWM signal generating unit that generates a pulse for driving the series resonance circuit based on the oscillation frequency. The phase comparing unit, the resonant frequency following oscillation unit, and the PWM signal generating unit are controlled digitally. Accordingly, PWM control is accomplished without considering a temperature change or a change of numerical value of component.

### CROSS-REFERENCE TO RELATED APPLICATIONS

This application claims the benefit of Japanese Patent Application No. 2010-283651, filed on Dec. 20, 2010, in the Japan Patent Office, and Korean Patent Application No. 10-2011-0049800, filed on May 25, 2011, in the Korean Intellectual Property Office, the disclosures of which are incorporated herein in their entireties by reference.

### BACKGROUND

1. Field

The present disclosure relates to an induction heating fuser unit and an image forming apparatus including the same.

2. Description of the Related Art

An image forming apparatus includes a fuser unit for fusing a toner image transferred onto a sheet, i.e., a recording medium. The fuser unit includes a fusing roller or a fusing belt (a heating roller) for fusing toner on the sheet and a pressing roller for pressing the fusing roller or the fusing belt against the sheet.

A fuser unit using an induction heating method and configured such that an induction heating coil is disposed in the fusing roller or the fusing belt in order to heat the fusing roller or the fusing belt has been widely used. In the induction heating method, a magnetic field formed in the induction heating coil passes through a conductive portion of the fusing roller or the fusing belt and an eddy current flows in the fusing roller or the fusing belt, thereby leading to Joule heating of the fusing roller or the fusing belt due to the eddy current.

### SUMMARY

The present disclosure provides an induction heating fuser unit and an image forming apparatus that includes the same and may perform pulse-width modulation (PWM) control by following a resonant frequency without considering a temperature change or a change of numerical value of component.

According to an aspect of the present disclosure, there is provided an induction heating fuser unit including a series resonance circuit that includes an induction coil and a condenser, the induction heating fuser unit including: a phase comparing unit that compares a phase of a pulse for driving the series resonance circuit with a phase of a current flowing through the induction coil to obtain a phase difference; a resonant frequency following oscillation unit that changes an oscillation frequency such that a driving frequency of the series resonance circuit follows a resonant frequency of the series resonance circuit by using the phase difference obtained by the phase comparing unit; and a PWM signal generating unit that generates a pulse for driving the series resonance circuit based on the oscillation frequency, wherein the phase comparing unit, the resonant frequency following oscillation unit, and the PWM signal generating unit are controlled digitally.

According to another aspect of the present disclosure, there is provided a method of following a resonant frequency of an induction heating fuser unit including a series resonance circuit that includes an induction coil and a condenser, the method including: comparing a phase of a pulse for driving the series resonance circuit with a phase of a current flowing through the induction coil to obtain a phase difference; changing an oscillation frequency such that a driving frequency of the series resonance circuit follows a resonant frequency of the series resonance circuit by using the phase difference; and generating a PWM signal for generating a pulse for driving the series resonance circuit based on the oscillation frequency, wherein the comparing of the phases, the changing of the oscillation frequency, and the generating of the PWM signal are controlled digitally.

Additional aspects and/or advantages will be set forth in part in the description which follows and, in part, will be apparent from the description, or may be learned by practice of the disclosure.

### BRIEF DESCRIPTION OF THE DRAWINGS

The above and other features and advantages of the present disclosure will become more apparent by describing in detail exemplary embodiments thereof with reference to the attached drawings in which:

FIG. 1 is a block diagram illustrating an induction heating fuser unit according to an embodiment of the present disclosure;

FIG. 2 is a graph illustrating a relationship between a frequency and an output of an up/down counter when a specific unavailable frequency band is set;

FIG. 3 is a graph illustrating a relationship between a current output and a duty ratio (ON time) of a pulse-width modulation (PWM) signal at a resonant frequency;

FIG. 4 is a block diagram illustrating a phase comparing unit included in an application specific integrated circuit (ASIC) of the induction heating fuser unit of FIG. 1;

FIG. 5 is a block diagram illustrating a resonant frequency following oscillation unit included in the ASIC of the induction heating fuser unit of FIG. 1;

FIG. 6 is a diagram illustrating a PWM signal generating unit included in the ASIC of the induction heating fuser unit of FIG. 1;

FIG. 7 is a diagram illustrating a waveform of the resonant frequency following oscillation unit when a duty ratio (ON time) of a PWM signal is changed in a state where a driving frequency of a drive voltage and a resonant frequency are the same;

FIG. 8 is a diagram illustrating a waveform of the resonant frequency following oscillation unit when a driving frequency of a driving voltage is higher than a resonant frequency;

FIG. 9 is a diagram illustrating a waveform of the resonant frequency following oscillation unit when a driving frequency of a driving voltage is lower than a resonant frequency;

FIG. 10 is a timing chart illustrating outputs of the resonant frequency following oscillation unit and the PWM signal generating unit when the induction heating fuser unit of FIG. 1 oscillates at an initial frequency;

FIG. 11 is a timing chart illustrating outputs of the resonant frequency following oscillation unit and the PWM signal generating unit when a resonant frequency is higher than an initial frequency; and

FIG. 12 is a timing chart illustrating outputs of the resonant frequency following oscillation unit and the PWM signal generating unit when a resonant frequency is lower than an initial frequency.

### DETAILED DESCRIPTION

The present disclosure will now be described more fully with reference to the accompanying drawings, in which exemplary embodiments of the disclosure are shown. Elements having substantially the same functions and configurations in the specification and the drawings are denoted by the same reference numerals and repeated explanations thereof will not be given.

In order to control power of an induction heating fuser unit, a method of controlling a drive frequency by using an LCR resonance circuit and a method of controlling the amount of current by performing pulse-width modulation (PWM) control when a resonance circuit resonates at a resonant frequency ‘f’ are used.

The method of controlling a driving frequency by using an LCR resonance circuit has a problem in that, since control is impossible if a resonant frequency of the resonance circuit is changed, a frequency at a highest power needs to be obtained and controlled as a lower limit frequency. Also, the method of controlling a driving frequency by using an LCR resonance circuit has a problem in that a frequency excessively increases during low power control, switching loss of a half-bridge output device increases, and efficiency decreases. Also, this method has another problem in that a power control method differs for high power, medium power, and low power. Also, the method of controlling a driving frequency by using an LCR resonance circuit has a problem in that if the half-bridge output device is switched where a driving frequency exceeds a resonant frequency, zero voltage switching is not performed, device loss increases, and degradation or thermal breakdown due to heat may occur.

Meanwhile, the method of controlling and changing the amount of current by performing PWM control when a resonance circuit resonates at a resonant frequency ‘f’ has a problem in that if a module in the circuit includes an analog circuit, a temperature change or a change of numerical value of component needs to be considered or all of the numerical value of component need to vary according to various conditions such as a resonant frequency following range. Also, the method controlling and changing the mount of current by performing PWM control when a resonance circuit resonates at a resonant frequency ‘f’ has a problem in that if there is a specific unavailable frequency band (for example, if there is a specific radio frequency or a resonant frequency of a fusing mechanism such as a fusing belt), it is difficult to automatically follow a resonant frequency beyond the specific unavailable frequency band.

Considering the above problems, the present disclosure provides an induction heating fuser unit and an image forming apparatus which may perform PWM control by following a resonant frequency without considering a temperature change or a change of numerical value of component.

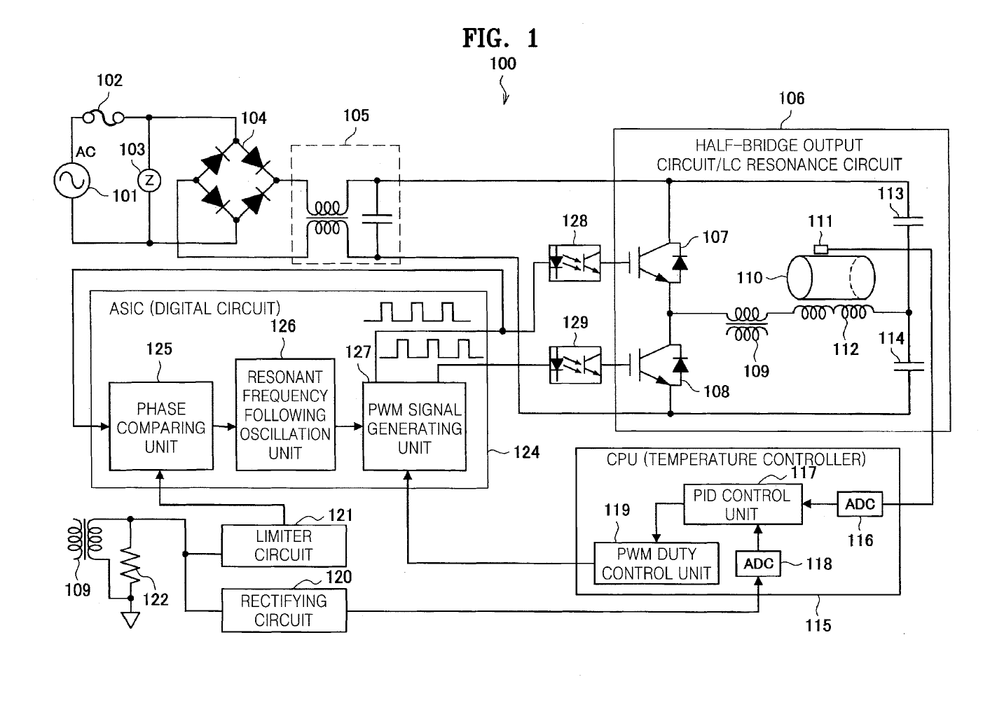

First, a structure of an induction heating fuser unit will be explained. FIG. 1 is a block diagram illustrating an induction heating fuser unit 100 according to an embodiment of the present disclosure. A structure of the induction heating fuser unit 100 will be explained with reference to FIG. 1.

The induction heating fuser unit 100 is a fuser unit using an induction heating method and configured such that an induction heating coil is disposed inside or outside a fusing roller or a fusing belt in order to heat the fusing roller or the fusing belt.

Referring to FIG. 1, the induction heating fuser unit 100 includes an alternating current (AC) power source 101, a fuse 102, a varistor 103, a diode bridge 104, a noise filter 105, a half-bridge output circuit 106, a central processing unit (CPU) 115, a rectifying circuit 120, a limiter circuit 121, and an application specific integrated circuit (ASIC) 124.

The half-bridge output circuit 106 includes insulated gate bipolar transistors (IGBTs) 107 and 108, a current transformer 109, a low loss induction heating coil 112, and condensers 113 and 114. The low loss induction heating coil 112 and the condensers 113 and 114 constitute an LC resonance circuit.

An IGBT or a field-effect transistor (FET) is used as a switching device for the half-bridge output circuit 106.

In FIG. 1, the IGBTs 107 and 108 are used as switching devices for the half-bridge output circuit 106. The LC resonance circuit including the low loss induction heating coil 112 and the condensers 113 and 114 generate a magnetic field by providing a high frequency current to the low loss induction heating coil 112 using a litz wire, which is an electric wire consisting of a plurality of thin copper strands twisted together. The magnetic field generated by the low loss induction heating coil 112 concentrates on a fusing roller or a fusing belt 110 formed of a material having high permeability so that an eddy current flows on a surface of a heating body and the fusing roller or the fusing belt 110 emits heat.

The CPU 115 measures a temperature of the fusing roller or the fusing belt 110 formed of a material having high permeability and controls a duty ratio of a PWM signal generated by a PWM signal generating unit 127 based on the measured temperature. The CPU 115 includes analog-digital (AD) converters 116 and 118, a proportional-integral-derivative (PID) control unit 117, and a PWM duly control unit 119.

The ASIC 124 generates a PWM signal by following a resonant frequency of the LC resonance circuit including the low loss induction heating coil 112 and the condensers 113 and 114, and includes a phase comparing unit 125, a resonant frequency following oscillation unit 126, and the PWM signal generating unit 127. In FIG. 1, since a structure of generating a PWM signal by following a resonant frequency of the LC resonance circuit includes a digital circuit, the ASIC (SOC) may include all these structures and the CPU 115.

The phase comparing unit 125 detects a phase difference between a PWM signal from among two PWM signals generated by the PWM signal generating unit 127 and a current flowing through the low loss induction heating coil 112 which is output by the limiter circuit 121 and detected by the current transformer 109. The resonant frequency following oscillation unit 126 enables an oscillation frequency of a PWM signal generated by the PWM signal generating unit 127 to follow a resonant frequency of the LC resonance circuit by using the phase difference detected by the phase comparing unit 125. In detail, the resonant frequency following oscillation unit 126 changes an oscillation frequency of a PWM signal according to an output of the phase comparing unit 125. The PWM signal generating unit 127 generates a PWM signal and outputs the same to a light-emitting diode and a photo transistor 128, 129 at an oscillation frequency that varies with a process performed by the resonant frequency following oscillation unit 126 to follow a resonant frequency of the LC resonance circuit.

The rectifying circuit 120 rectifies an output of the current transformer 109, and outputs the rectified output to the AD converter 118 of the CPU 115. The limiter circuit 121 restricts an output voltage of the current transformer 109 to a predetermined range. The limiter circuit 121 outputs an output voltage of the current transformer 109 within a predetermined range to the phase comparing unit 125 of the ASIC 124. In addition, a resistor 122 is for a current to flow from the current transformer 109.

In the induction heating fuser unit 100 of FIG. 1, an output from the AC power source 101 is subjected to full-wave rectification in the diode bride 104, and is transmitted through the noise filter 105 to the half-bridge output circuit 106.

Since the IGBTs 107 and 108 of the half-bridge output circuit 106 are alternately switched on and off, a current passing through the noise filter 105 flows through the low loss induction heating coil 112 with the current transformer 109 therebetween. A magnetic field may be generated from the low loss induction heating coil 112 by applying a high frequency current through the low loss induction heating coil 112. The magnetic field generated by the low loss induction heating coil 112 concentrates on the fusing roller or the fusing belt 110 formed of a material having high permeability. Due to the magnetic field generated by the low loss induction heating coil 112, an eddy current flows on a surface of a heating body to emit heat.

An LC resonance used in the induction heating fuser unit 100 of FIG. 1 will be explained. In an LCR series resonance circuit including an LC resistance component, an impedance Z of the LCR series resonance circuit is defined by Equation 1.

$$\begin{matrix}Z = R + sL + \frac{1}{sC} \\ = R + jω L + \frac{1}{jω C} \\ = R + j ( ω L - \frac{1}{ω C} )\end{matrix} \\ Z = R + j X \\ X = ( ω L - \frac{1}{ω C} ) . \qquad ( 1 )$$

If a frequency when x=0 is ω₀, a series resonant frequency f₀ is defined by Equation 2.

$${ω}_{0} L = \frac{1}{{ω}_{0} C} \\ {ω}_{0} = \frac{1}{\sqrt{LC}} \\ {f}_{0} = \frac{1}{2 π \sqrt{LC}} . \qquad ( 2 )$$

If the impedance Z of the LCR series resonance circuit is expressed with a complex vector, the impedance Z, a magnitude |Z| of the impedance Z, and a phase a of the impedance Z are defined by Equation 3.

$$\begin{matrix}Z = R + j X \\ = \vert Z \vert cos α + j \vert Z \vert sin α \\ = \vert Z \vert ( cos α + jsinα ) \\ = \vert Z \vert {ɛ}^{jα}\end{matrix} \\ \begin{matrix}\vert Z \vert = \sqrt{{R}^{2} + {X}^{2}} \\ = \sqrt{{R}^{2} + {( ω L - \frac{1}{ω C} )}^{2}}\end{matrix} \\ \begin{matrix}α = {tan}^{- 1} ( \frac{X}{R} ) \\ = {tan}^{- 1} ( \frac{ω L - \frac{1}{ω C}}{R} ) .\end{matrix} \qquad ( 3 )$$

That is, the magnitude |Z| of the impedance Z has a minimum value because an inductance and a capacitance are offset at the series resonant frequency f₀, and thus, only a resonance component R is obtained.

A current I, a magnitude |I| of the current I, and a phase φ of the current I when a voltage source V is connected to the LCR series resonance circuit are defined by Equation 4.

$$\begin{matrix}I = \frac{V}{Z} \\ = \frac{V}{\vert Z \vert {ɛ}^{jα}} \\ = \frac{V {ɛ}^{- jα}}{\vert Z \vert}\end{matrix} \\ I = \vert I \vert {ɛ}^{jφ} \\ \begin{matrix}\vert I \vert = \frac{V}{\vert Z \vert} \\ = \frac{V}{\sqrt{{R}^{2} + {( ω L - \frac{1}{ω C} )}^{2}}}\end{matrix} \\ \begin{matrix}φ = - α \\ = - {tan}^{- 1} ( \frac{X}{R} ) \\ = - {tan}^{- 1} ( \frac{ω L - \frac{1}{ω C}}{R} ) .\end{matrix} \qquad ( 4 )$$

Accordingly, as shown in the above equations, when the LCR series resonance circuit is driven, the current I has a maximum value and the current I and the voltage V have the same phase at the series resonant frequency f₀. The LC resonance used in the induction heating fuser unit 100 of FIG. 1 has been described above.

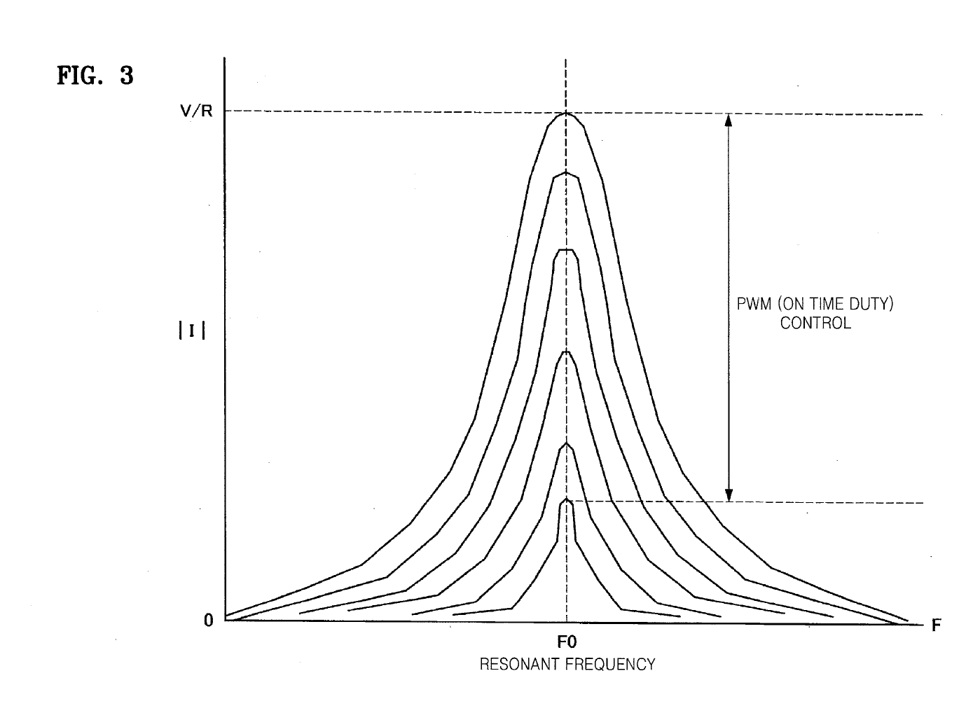

FIG. 3 is a graph illustrating a relationship between a current output of an LCR series resonance circuit and a duty ratio (ON time (high time)) of a PWM signal at a resonant frequency. While an absolute value of a current is changed at about a resonant frequency, the absolute value of the current varies according to a duty ratio (ON time) of a PWM signal. That is, as an ON time of a PWM signal generated by the PWM signal generating unit 127 increases, ON times of the IGBTs 107 and 108 increase accordingly, and thus, an absolute value of a current of the LCR series resonance circuit increases.

The structure of the induction heating fuser unit 100 of FIG. 1 has been described above. A structure of the ASIC 124 of FIG. 1 will be explained in detail. First, a structure of the phase comparing unit 125 is explained.

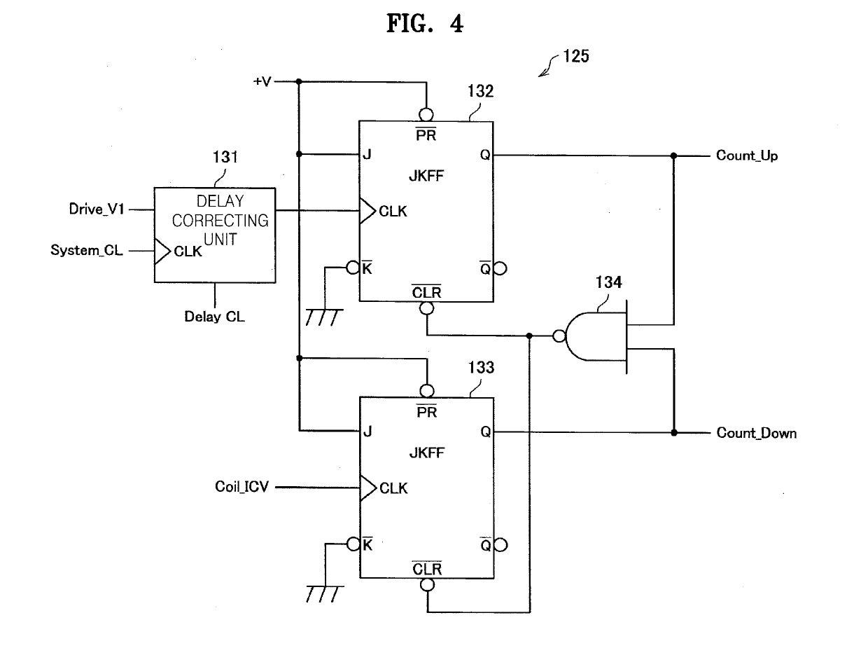

FIG. 4 is a block diagram illustrating the phase comparing unit 125 included in the ASIC 124 of the induction heating fuser unit 100 of FIG. 1. A structure of the phase comparing unit 125 will be explained with reference to FIG. 4.

Referring to FIG. 4, the phase comparing unit 125 includes a delay correcting unit 131, JK flip-flops (JKFFs) 132 and 133, and a negated AND (NAND) gate 134.

The delay correcting unit 131 sets a delay correction value of a coil current phase comparison voltage Coil_ICV) which delays from a driving voltage Drive_V1 generated by the PWM signal generating unit 127. The driving voltage Drive_V1, a system clock System _CL, and a delay clock Delay _CL are input to the delay correcting unit 131, and a clock is output to the JKFF 132. The coil current phase comparison voltage Coil_ICV output from the limiter circuit 121 is applied to the JKFF 133.

Each of the JKFFs 132 and 133 outputs in synchronization with the clock a signal corresponding to a new state through an output terminal Q and an inverted output terminal Q based on a combination of states of input terminals J and K. The JKFF 132 outputs 1 (logic high) from the terminal Q when a phase of a current flowing through the low loss induction heating coil 112 is slower than a phase of the drive voltage Drive_V1 generated by the PWM signal generating unit 127. Accordingly, an output Count_Up becomes high. Meanwhile, the JKFF 133 outputs 1 (logic high) when a phase of a current flowing through the low loss induction heating coil 112 is faster than a phase of the driving voltage Drive_V1 generated by the PWM signal generating unit 127. Accordingly, an output Count_Down becomes high.

Since the phase comparing unit 125 is configured as shown in FIG. 4, the output Count_Up becomes high when the coil current phase comparison voltage Coil_ICV output from the limiter circuit 121 is slower than the driving voltage Drive_V1, and the output Count_Down becomes high when the coil current phase comparison voltage Coil_ICV is faster than the driving voltage Drive_V1.

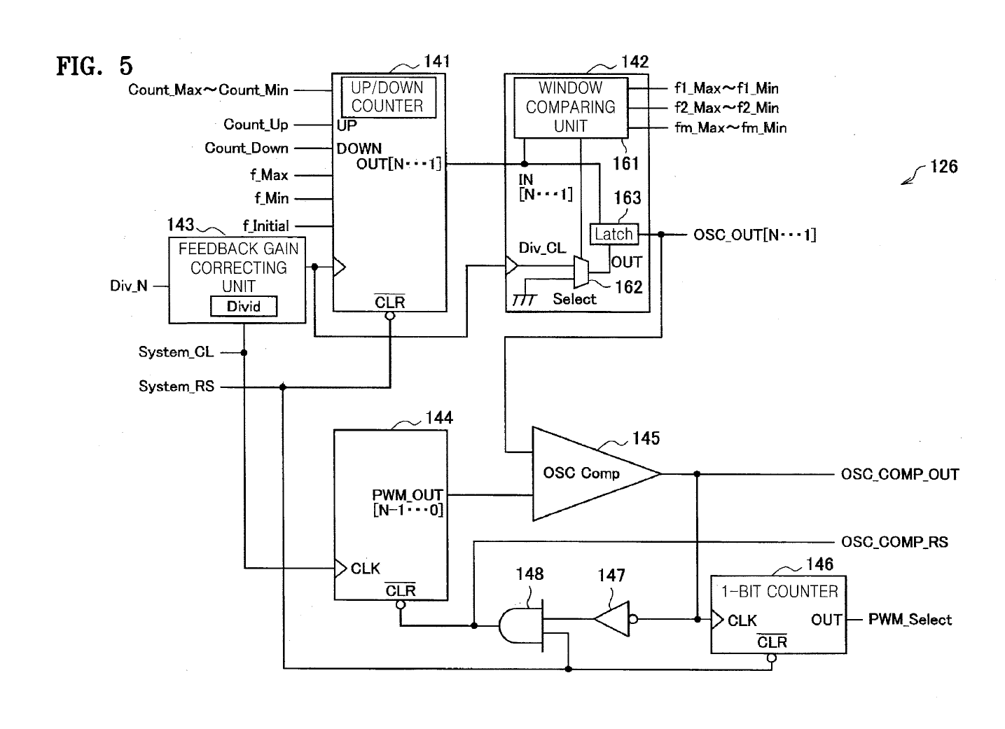

Next, a structure of the resonant frequency following oscillation unit 126 will be explained. FIG. 5 is a block diagram illustrating the resonant frequency following oscillation unit 126 included in the ASIC 124 of the induction heating fuser unit 100 of FIG. 1. A structure of the resonant frequency following oscillation unit 126 will be explained with reference to FIG. 5.

Referring to FIG. 5, the resonant frequency following oscillation unit 126 includes an up/down counter 141, a frequency comparing unit 142, a feedback gain correcting unit 143, a PWM counter 144, an OSC comparator 145, a 1-bit counter 146, a NOT gate 147, and an AND gate 148.

The up/down counter 141 to which an output Count_Up or Count_down of the phase comparing unit 125 and other parameters are input increments its count while the output Count_Up is high to reduce an oscillation frequency and decrements its count while the output Count_Down is high to increase an oscillation frequency.

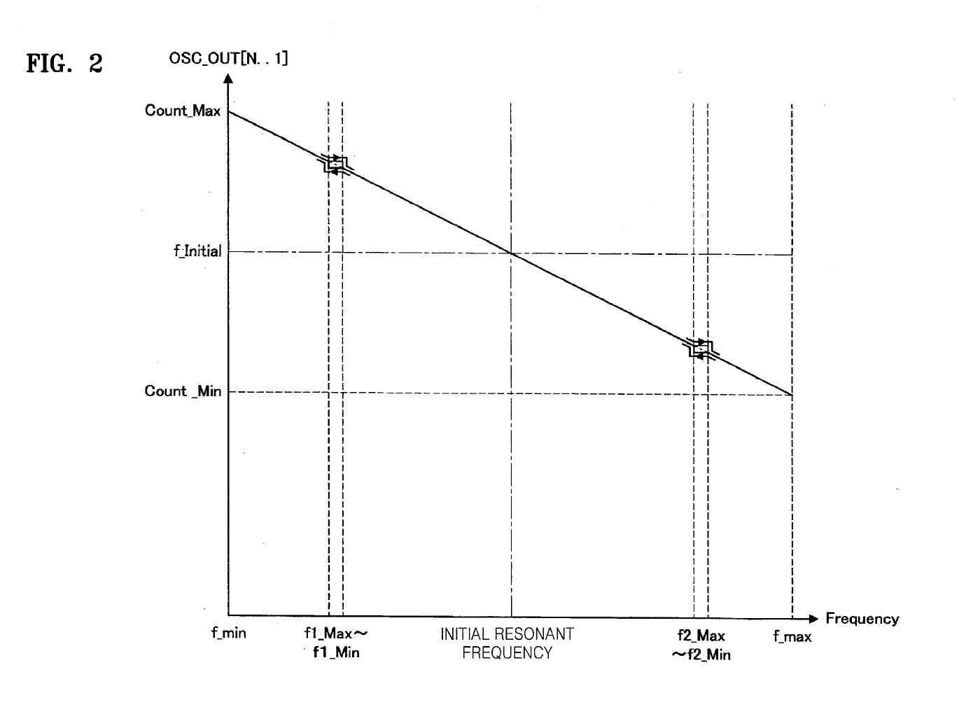

Other parameters input to the up/down counter 141 may include Count_Max-Count_Min which is a range of an output OSC_OUT[N . . . 1] of the frequency comparing unit 142 (see FIG. 2), f_Min which is a frequency corresponding to the value Count_Max, f_Max which is a frequency corresponding to the value Count_Min, and an initial resonant frequency f_initial.

Although the induction heating fuser unit 100 is required to have a precise function like a communication apparatus, since the induction heating fuser unit 100 is not much required to have a jitter-related function in resonant frequency following characteristics, the up/down counter 141 having a simple structure may be used in order to follow a resonant frequency of an LCR series resonance circuit.

The frequency comparing unit 142 compares an oscillation frequency with a specific unavailable frequency band (for example, a specific radio frequency or a resonant frequency of a fusing mechanism such as the fusing roller or the fusing belt 110). As shown in FIG. 5, the frequency comparing unit 142 includes a window comparator 161, a comparison circuit 162, and a latch circuit 163.

The window comparator 161 compares an output of the up/down counter 141 with specific unavailable frequency bands f1_Max˜f1_Min, f2_Max˜f2_Min, . . . , fm_Max˜fm_Min. The window comparator 161 outputs a high signal when the output of the up/down counter 141 corresponds to the specific unavailable frequency band.

FIG. 2 is a graph illustrating a relationship between a frequency and an output of the up/down counter 141 that passed through the frequency comparing unit 142 when a specific unavailable frequency band is set. In FIG. 2, a horizontal axis represents a frequency, and a vertical axis represents a final output OSC_OUT[N . . . 1] of the up/down counter 141 that passed through the frequency comparator 142. An initial resonant frequency f₀ corresponds to f_Initial, a lower limit frequency f_Min corresponds to Count_Max, and an upper limit frequency f_Max corresponds to Count_Min. Accordingly, a frequency and an output of the up/down counter 141 are inversely proportional to each other.

If an output OUT[N . . . 1] of the up/down counter 141 enters an unavailable frequency band, a frequency in a previous available frequency band output from the latch circuit 163 is used and a frequency in the unavailable frequency band is not used, and the output OUT[N . . . 1] of the up/down counter 141 is changed. If the output OUT[N . . . 1] escapes from the unavailable frequency band, the output OSC_OUT[N . . . 1] of the latch circuit 163 becomes an output frequency when the output OUT[n . . . 1] escapes from the unavailable frequency band.

The PWM counter 144 provides an output PWM_OUT[N−1 . . . 0] based on a system clock System_CL. The OSC comparator 145 compares the output OSC_OUT[N . . . 1] of the frequency comparing unit 142 with the output PWM_OUT[N−1 . . . 0] of the PWM counter 144 and provides an output OSC_COMP_OUT. If the output OSC_OUT[N . . . 1] of the frequency comparing unit 142 and the output PWM_OUT[N−1.0] of the PWM counter 144 are the same, the OSC comparator 145 changes an output from logic low to logic high during a predetermined period of time, and notifies the PWM signal generating unit 127 that one cycle of a resonant frequency is completed.

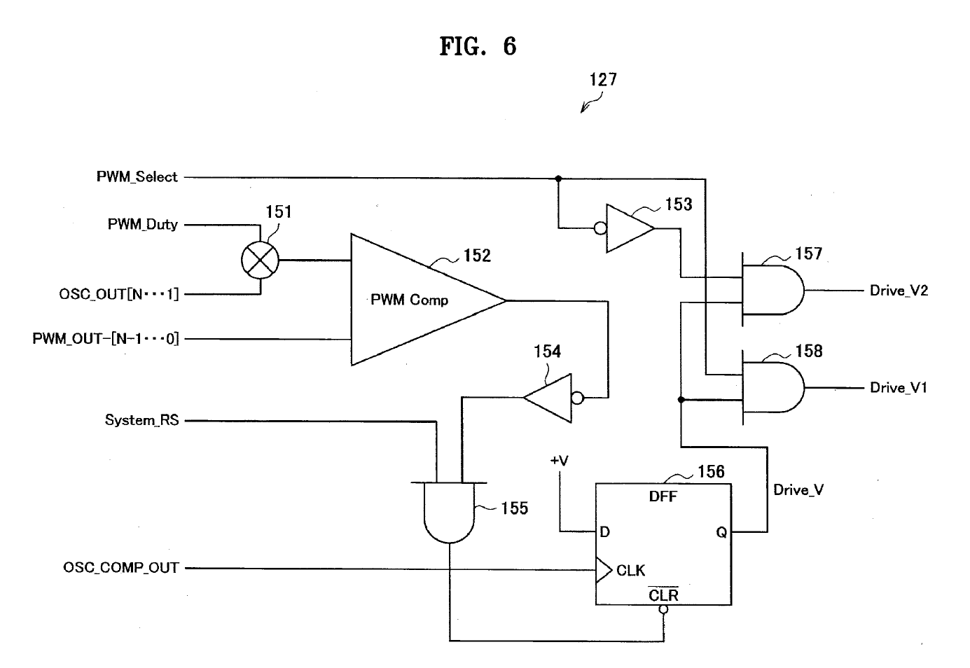

A structure of the PWM signal generating unit 127 will be explained. FIG. 6 is a diagram illustrating the PWM signal generating unit 127 included in the SIC 124 of the induction heating fuser unit 100 of FIG. 1. A structure of the PWM signal generating unit 127 will be explained with reference to FIG. 6.

Referring to FIG. 6, the PWM signal generating unit 127 includes a multiplier 151, a PWM comparator 152, NOT gates 153 and 154, AND gates 155, 157, and 158, and a D flip-flop (DFF) 156.

The PWM comparator 152 compares an output PWM_OUT[N−1 . . . 0] of the PWM counter 144 with a value obtained by multiplying information PWM_Duty about a duty ratio provided by the PWM duty control unit 119 by an output OSC_OUT[N . . . 1] of the frequency comparing unit 142 by using the multiplier 151, and outputs a result of the comparison to the NOT gate 154.

The DFF 156 receives an output OSC_COMP_OUT of the OSC comparator 145 and outputs a voltage Drive_V. The DFF 156 outputs the voltage Drive_V to the AND gates 157 and 158. The AND gates 157 and 158 respectively output drive voltages Drive_V1 and Drive_V2 by using a signal PWM_Select output by the 1-bit counter 146.

That is, the PWM signal generating unit 127 outputs the voltage Drive_V that is an origin of the driving voltages Drive_V1 and Drive_V2 which are logic high during a predetermined period of time when the output OSC_COMP_OUT is logic high. The predetermined period of time is indicated by the PWM duty control unit 119, and information about the predetermined period of time corresponds to the information PWM_Duty provided to the PWM comparator 152.

Since the PWM signal generating unit 127 is configured as shown in FIG. 6, a PWM timing is calculated from an output of the up/down counter 141 and an ON time calculated by the CPU 115. If the PWM timing is the same as an output PWM_OUT[N−1 . . . 0] of the PWM counter 144 using a reset counter, the DFF 156 changes the voltage Drive_V to logic low. Accordingly, the driving voltages Drive_V1 and Drive_V2 which are logic high during a period of the ON time are generated, the light-emitting diode is logic high during that period of time, the photo transistor is turned on, and thus, the IGBTs 107 and 108 are turned on, thereby making a current flow through the LC series resonance circuit.

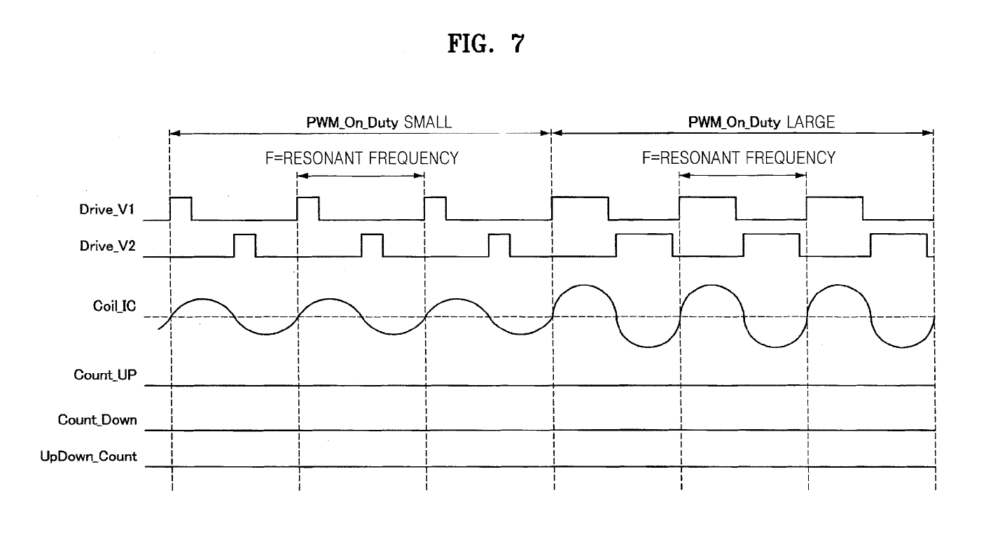

The structures of the phase comparing unit 125, the resonant frequency following oscillation unit 126, and the PWM signal generating unit 127 have been described above. An operation of the resonant frequency following oscillation unit 126 will be explained. FIGS. 7 through 9 are waveforms of the resonant frequency following oscillation unit 126.

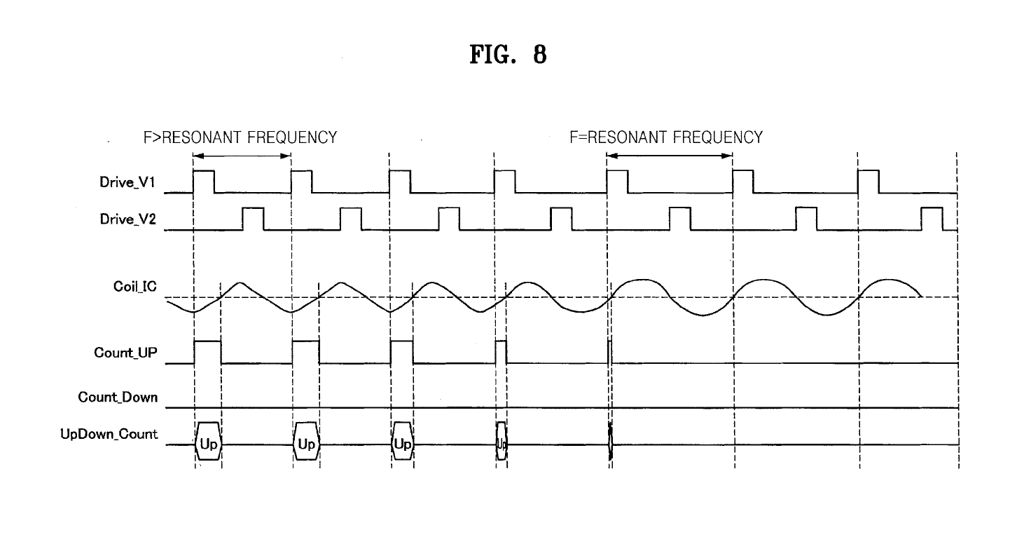

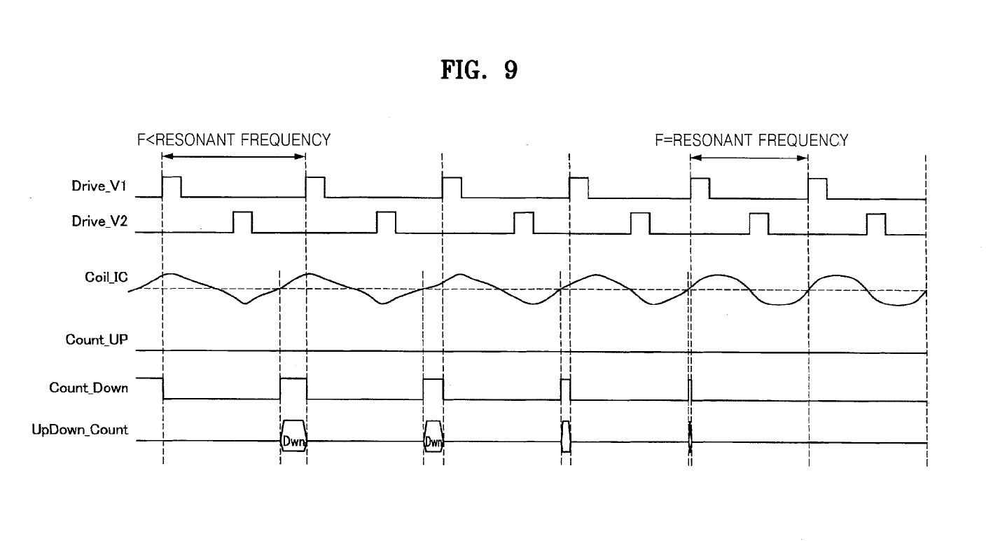

FIG. 7 is a diagram illustrating a waveform of the resonant frequency following oscillation unit 126 when driving frequencies of the driving voltages Drive_V1 and Drive_V2 and a resonant frequency are the same. FIG. 8 is a diagram illustrating a waveform of the resonant frequency following oscillation unit 126 when driving frequencies of the driving voltages Drive_V1 and Drive_V2 are higher than a resonant frequency. FIG. 9 is a diagram illustrating a waveform of the resonant frequency following oscillation unit 126 when driving frequencies of the driving voltages Drive_V1 and Drive_V2 are lower than a resonant frequency.

FIG. 7 illustrates a state where a peak value of a current flowing through a coil varies according to whether a duty ratio of each of the driving voltages Drive_V1 and Drive_V2 is a large duty ratio or a small duty ratio (ON time). The small or large duty ratio (ON time) of each of the driving voltages Drive_V1 and Drive_V2 is changed under the control of the PWM duty control unit 119.

In FIG. 7, since a driving frequency of a drive voltage and a resonant frequency are the same, an output Count_Up or Count_Down of the phase comparing unit 125 is always logic low, and thus, an output UpDown_Count of the up/down counter 141 is not provided.

FIGS. 8 and 9 are waveforms for explaining feedback control which is performed such that a driving frequency is the same as a resonant frequency by detecting a phase difference from waveforms of a coil current and a driving voltage and incrementing or decrementing a count of the up/down counter 141.

An operation of the resonant frequency following oscillation unit 126 when a driving frequency of a driving voltage is higher than a resonant frequency will be explained with reference to FIG. 8. When a driving frequency of a driving voltage is higher than a resonant frequency, since a phase of a current flowing through a coil is slower, an output Count_Up from among outputs of the phase comparing unit 125 becomes logic high. A period of time for which the output Count_Up is logic high refers to a period of time from when a driving voltage Drive_V1 completely changes from logic low to logic high to when a phase of a coil current is 0.

If the output Count_Up from among outputs of the phase comparing unit 125 becomes logic high, the up/down counter 141 increments a count and outputs the same during a period of time for which the output Count_Up is logic high. Accordingly, drive frequencies of the driving voltages Drive_V1 and Drive_V2 may follow a resonant frequency.

Meanwhile, an operation of the resonant frequency following oscillation unit 126 when a driving frequency of a driving voltage is lower than a resonant frequency will be explained with reference to FIG. 9. When a driving frequency of a driving voltage is lower than a resonant frequency, since a phase of a current flowing through a coil is faster, an output Count_Down from among outputs of the phase comparing unit 125 becomes logic high. A period of time for which the output Count_Down is logic high refers to a period of time from when a phase of a coil current is 0 to a time when a driving voltage Drive_V1 completely changes from logic low to logic high.

If the output Count_Down from among outputs of the phase comparing unit 125 becomes logic high, the up/down counter 141 decrements a count and outputs the same during a period of time for which the output Count_Down is logic high. Accordingly, driving frequencies of the driving voltages Drive_V1 and Drive_V2 may follow a resonant frequency.

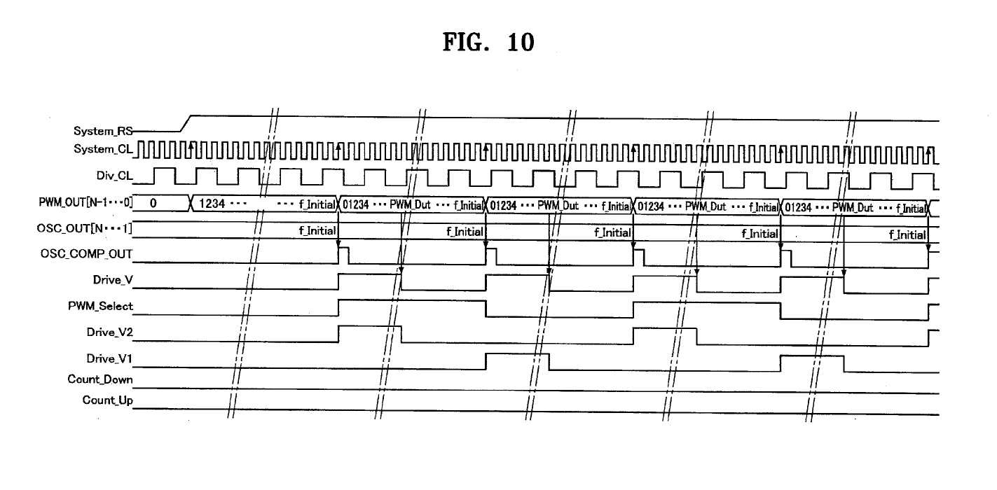

Operations of the resonant frequency following oscillation unit 126 and the PWM signal generating unit 127 will be explained. FIGS. 10 through 12 are timing charts illustrating outputs of the resonant frequency following oscillation unit 126 and the PWM signal generating unit 127.

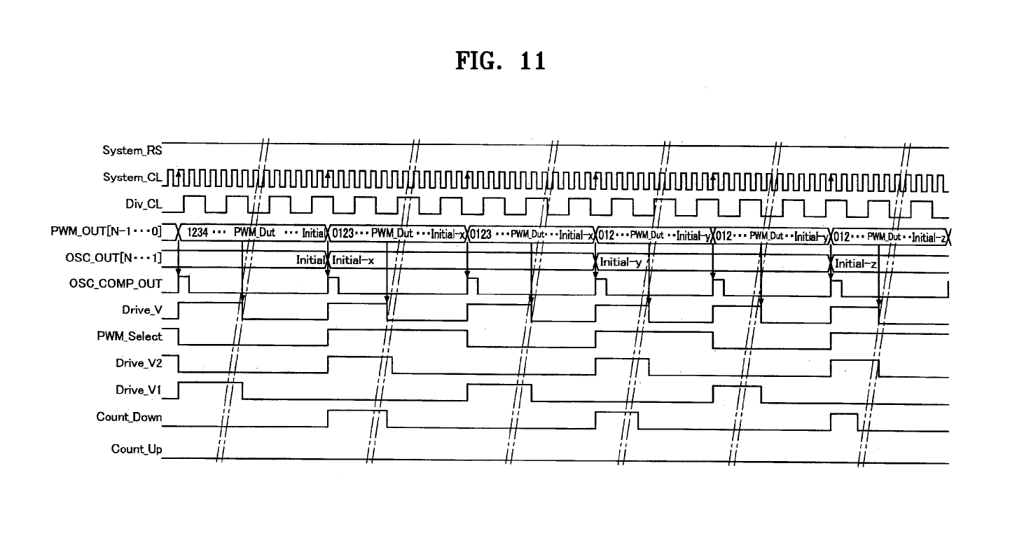

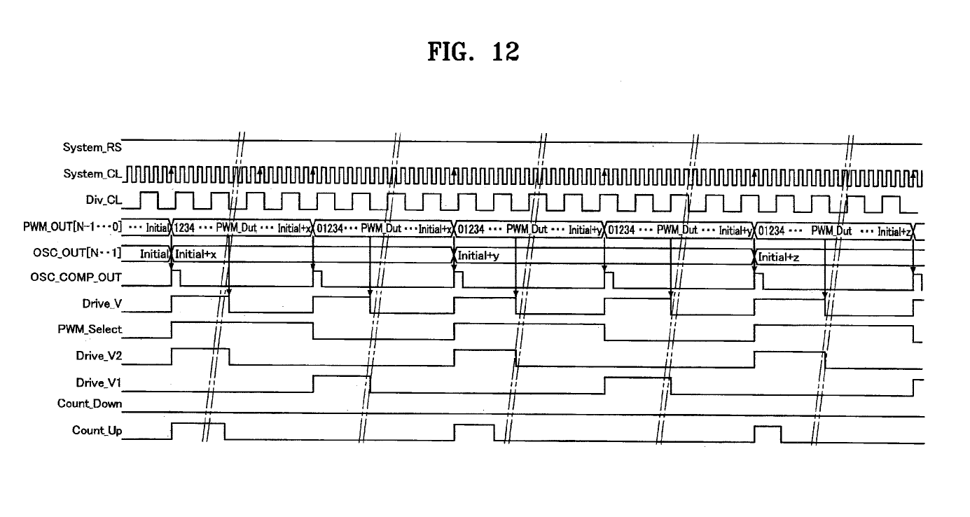

FIG. 10 is a timing chart when a power source of the induction heating fuser unit 100 is turned on and then the induction heating fuser unit 100 oscillates at an initial frequency (=a resonant frequency). FIG. 11 is a timing chart when a resonant frequency is higher than an initial frequency. FIG. 12 is a timing chart when a resonant frequency is lower than an initial frequency.

Operations of the resonant frequency following oscillation unit 126 and the PWM signal generating unit 127 when a power source of the induction heating fuser 100 is turned on and the induction heating fuser unit 100 oscillates at an initial frequency (=a resonant frequency) will be explained with reference to FIG. 10. If an output PWM_OUT[N−1 . . . 0] of the PWM counter 144 corresponds to an initial frequency f_initial, the output PWM_OUT[N−1 . . . 0] of the PWM counter 144 is reset, an output OSC_COMP_OUT of the OSC comparator 145 changes from logic low to logic high, and a voltage Drive_V of the DFF 156 changes from logic low to logic high. Due to a combination of an output of the 1-bit counter 146 and the voltage Drive_V of the DFF 156, the drive voltages Drive_V1 and Drive_V2 are respectively output from the AND gates 157 and 158.

Operations of the resonant frequency following oscillation unit 126 and the PWM signal generating unit 127 when a resonant frequency is higher than an initial frequency will be explained with reference to FIG. 11. If a resonant frequency is higher than an initial frequency, an output Count_Down from among outputs of the phase comparing unit 125 becomes high. Accordingly, since a period of time for which an output OSC_COMP_OUT of the OSC comparator 145 changes from logic low to logic high is shortened (Initial→Initial−x→Initial−y→Initial−z), a period of time for which the voltage Drive_V of the DFF 156 changes from logic low to logic high is changed. Accordingly, a driving frequency of a driving voltage is controlled to be the same as a resonant frequency.

Operations of the resonant frequency following oscillation unit 126 and the PWM signal generating unit 127 when a resonant frequency is lower than an initial frequency will be explained with reference to FIG. 12. If a resonant frequency is lower than an initial frequency, an output Count_Up from among outputs of the phase comparing unit 125 becomes high. Accordingly, since a period of time for which an output OSC_COMP_OUT of the OSC comparator 145 changes from logic low to logic high is lengthened (Initial→Initial+x→Initial+y→Initial+z), a period of time for which the voltage Drive_V of the DFF 156 changes from logic low to logic high is changed. Accordingly, a driving frequency of a driving voltage is controlled to be the same as a resonant frequency.

As such, a driving frequency of a driving voltage is controlled to be the same as a resonant frequency by incrementing or decrement a count of the up/down counter 141 based on a phase difference between a driving voltage and a coil current, and a PWM duty ratio is obtained by the PWN duty control unit 119 by using a PWM duty correction value obtained by PID calculation by the PID control unit 117 from an output of a temperature sensor 111 and an output of the up/down counter 141.

If an output of the PWM counter 144 is the same as a PWM duty ratio, a driving voltage changes to logic low, and if an output of the PWM counter 144 is the same as an output of the up/down counter 141, a driving voltage changes to logic high, to obtain a resonant frequency PWM signal, that is, a voltage Drive_V. As a half-cycle select signal generated by the 1-bit counter 156 and a resonant frequency PWM signal generated by the DFF 156 are input to the AND gates 157 and 158, the driving voltages Drive_V1 and Drive_V2 are alternately output to half bridge output circuit 106.

Since the resonant frequency following oscillation unit 126 and the PWM signal generating unit 127 of the induction heating fuser unit 100 are simply configured to include a digital circuit by using the up/down counter 141 and the PWM counter 144 as described above, the resonant frequency following oscillation unit 126 and the PWM signal generating unit 127 may be received in the ASIC 124.

Accordingly, since use of the induction heating fuser unit 100 according to the present disclosure may reduce the number of hardware components compared to use of a conventional induction heating fuser unit, costs are reduced and assemblability is improved. Also, since the induction heating fuser unit 100 changes a set value by using software without considering a temperature change or a change of numerical value of component by including a digital circuit, compatibility with all specifications is improved without any hardware change, unlike the case of the conventional induction heating fuser unit where an analog circuit is included and thus it is necessary to change all of the numerical value of component according to specifications such as a resonant frequency following range or to consider a temperature change or a change of numerical value of component.

Also, since the induction heating fuser unit 100 according to the present disclosure performs control in a digital circuit, when there is a specific unavailable frequency band (for example, a specific radio frequency or a resonant frequency of a fusing mechanism such as a fusing belt), control may be simply performed by setting a frequency range.

As described above, the induction heating fuser unit according to the present disclosure may perform PWM control by following a resonant frequency without considering a temperature change or a change of numerical value of component, and reduce the number of hardware components, thereby reducing costs and improving assemblability.

While the present disclosure has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An induction heating fuser unit comprising a series resonance circuit that comprises an induction coil and a condenser, the induction heating fuser unit comprising:
a phase comparing unit that compares a phase of a pulse for driving the series resonance circuit with a phase of a current flowing through the induction coil to obtain a phase difference;
a resonant frequency following oscillation unit that changes an oscillation frequency such that a driving frequency of the series resonance circuit follows a resonant frequency of the series resonance circuit by using the phase difference obtained by the phase comparing unit; and
a pulse-width modulation (PWM) signal generating unit that generates a pulse for driving the series resonance circuit based on the oscillation frequency,
wherein the phase comparing unit, the resonant frequency following oscillation unit, and the PWM signal generating unit are controlled digitally.

2. The induction heating fuser unit of claim 1, wherein the phase comparing unit compares a phase of a pulse generated by the PWM signal generating unit with a phase of a current flowing through the induction coil and outputs a signal according to a phase difference to the resonant frequency following oscillation unit, and
the resonant frequency following oscillation unit comprises a counter that changes an oscillation frequency based on the signal output by the phase comparing unit.

3. The induction heating fuser unit of claim 2, wherein the counter is an up/down counter, and
if the phase of the current flowing through the induction coil is slower than the phase of the pulse generated by the PWM signal generating unit, lowers the oscillation frequency by incrementing a count.

4. The induction heating fuser unit of claim 1, wherein the resonant frequency following oscillation unit comprises a frequency comparing unit that enables the oscillation frequency to avoid a specific unavailable frequency band.

5. The induction heating fuser unit of claim 4, wherein the frequency comparing unit comprises:
a window comparator that determines whether the oscillation frequency corresponds to an unavailable frequency band based on information about the predetermined unavailable frequency band; and
a latch circuit that outputs the oscillation frequency according to a result of the determination.

6. The induction heating fuser unit of claim 5, wherein the latch circuit,
if the window comparator determines that the oscillation frequency is available, outputs the available oscillation frequency and stores the output oscillation frequency, and
if the window comparator determines that the oscillation frequency is not available, outputs again the oscillation frequency stored in and previously output by the latch circuit.

7. The induction heating fuser unit of claim 1, further comprising a PWM duty control unit that adjusts a duty ratio of a pulse generated by the PWM signal generating unit.

8. The induction heating fuser unit of claim 7, wherein the PWM duty control unit adjusts a duty ratio of a pulse generated by the PWM signal generating unit according to a temperature of a fusing roller or a fusing belt that receives a magnetic field generated by the induction coil and emits heat.

9. The induction heating fuser unit of claim 7, wherein the PWM signal generating unit comprises:
a multiplier;
a PWM comparator;
NOT gates;
AND gates; and
a D flip-flop (DFF).

10. The induction heating fuser unit of claim 1, further comprising:
an alternating current (AC) power source;
a fuse;
a varistor;
a diode bridge;
a noise filter;
a half-bridge output circuit;
a central processing unit (CPU);
a rectifying circuit;
a limiter circuit; and
an application specific integrated circuit (ASIC).

11. The induction heating fuser unit of claim 10, wherein the half-bridge output circuit comprises:
a plurality of insulated gate bipolar transistors (IGBTs);
a current transformer;
a low loss induction heating coil; and
a plurality of condensers.

12. An image forming apparatus comprising an induction heating fuser unit comprising a series resonance circuit that comprises an induction coil and a condenser, the induction heating fuser unit comprising:
a phase comparing unit that compares a phase of a pulse for driving the series resonance circuit with a phase of a current flowing through the induction coil to obtain a phase difference;
a resonant frequency following oscillation unit that changes an oscillation frequency such that a driving frequency of the series resonance circuit follows a resonant frequency of the series resonance circuit by using the phase difference obtained by the phase comparing unit; and
a pulse-width modulation (PWM) signal generating unit that generates a pulse for driving the series resonance circuit based on the oscillation frequency,
wherein the phase comparing unit, the resonant frequency following oscillation unit, and the PWM signal generating unit are controlled digitally.

13. A method of following a resonant frequency of an induction heating fuser unit comprising a series resonance circuit that comprises an induction coil and a condenser, the method comprising:
comparing a phase of a pulse for driving the series resonance circuit with a phase of a current flowing through the induction coil to obtain a phase difference;
changing an oscillation frequency such that a driving frequency of the series resonance circuit follows a resonant frequency of the series resonance circuit by using the phase difference; and
generating a PWM signal for generating a pulse for driving the series resonance circuit based on the oscillation frequency,
wherein the comparing of the phases, the changing of the oscillation frequency, and the generating of the PWM signal are controlled digitally.
